(19) United States
(12) Patent Application Publication
(10) Pub. No.: US 2013/0225095 A1
(43) Pub. Date: Aug. 29, 2013

(54) METHOD FOR REDUCING INTERMODULATION NOISE SIGNAL AND COMMUNICATION TERMINAL

(71) Applicant: PANTECH CO., LTD., (US)

(72) Inventors: Seok Jin Hong, Seoul (KR); Yong Chun Song, Seoul (KR)

(73) Assignee: PANTECH CO., LTD., Seoul (KR)

(21) Appl. No.: 13/779,068

(22) Filed: Feb. 27, 2013

(30) Foreign Application Priority Data
Feb. 29, 2012 (KR) 10-2012-0021385

(51) Int. Cl. H04B 15/00

(52) U.S. Cl. CPC H04B 15/00
USPC 455/73

(57) ABSTRACT

A communication terminal apparatus to reduce an intermodulation noise between channels may perform wireless communication at different frequencies using a first channel and a second channel. The communication terminal apparatus may include a sensing unit to measure a signal to noise ratio (SNR) in a communication associated with the second channel, a determining unit to determine whether the measured SNR is less than a first threshold, and an output controller to decrease a strength of an output signal in the communication associated with the first channel if the measured SNR is less than the first threshold, and to increase the strength of the output signal in the communication associated with the first channel until the SNR is substantially similar to the first threshold if the determining unit determines that the measured SNR is greater than the first threshold.

### CROSS-REFERENCE TO RELATED APPLICATION

This application claims priority from and the benefit of Korean Patent Application No. 10-2012-0021385, filed on Feb. 29, 2012, which is hereby incorporated by reference for all purposes as if fully set forth herein.

### BACKGROUND

1. Field

The following description relates to a method for reducing a noise signal generated if a transmitting signal of an antenna is received by another antenna.

2. Discussion of the Background

Wireless data transmission using a communication terminal may be generalized and communication terminals may include a plurality of antennas to transmit signals of different frequencies, often simultaneously.

However, among the plurality of antennas, if a signal transmitted by an antenna A is received by an antenna B, the signal transmitted by antenna A may act as a noise signal in antenna B. If the signal transmitted by the antenna A is combined with a transmitting signal of the antenna B and intermodulation may occur, a communication quality of the antenna B may be degraded.

For example, if data transmission is performed while a voice call is being performed using a communication terminal, a portion of a data transmitting signal may be received by a receiving end of the voice call during the data transmission. In this instance, intermodulation noise of a voice channel, and the like, may be generated and a communication quality may be degraded.

Among technologies to reduce deterioration in a communication quality resulting from the intermodulation noise, a Simultaneous Voice and Long Term Evolution (SVLTE) service has been commercialized. In the related SVLTE service, in order to resolve the intermodulation in simultaneous signal transmission of antennas, a strength of a long term evolution (LTE) transmitting signal, corresponding to a data signal, may be decreased uniformly, based on a strength of a Code Division Multiple Access (CDMA) 1X transmitting signal corresponding to a voice call signal.

In the related technology, a predetermined look-up table (LUT) may be used to adjust the strength of the LTE transmitting signal based on a level of the strength of the CDMA 1X transmitting signal. If a distance from a base station is relatively great, or the strength of the CDMA 1X transmitting signal is relatively great because a voice call is being performed, a scheme of decreasing the strength of the LTE transmitting signal corresponding to a data communication transmitting signal may be used.

However, in the related technology, although a level of noise caused by an intermodulation signal may be changed since a level of the LTE transmitting signal to be received by a CDMA 1X receiving end keeps changing in real time, depending on a peripheral environment and/or a manner of grapping a communication terminal, the strength of the LTE transmitting signal may be decreased based on only the strength of the CDMA 1X transmitting signal. Accordingly, there may be unnecessary restrictions on data communication.

For example, if a signal to noise ratio (SNR) of a corresponding channel is sufficiently great, and the quality of the voice call does not deteriorate, although the strength of the CDMA 1X transmitting signal is relatively great, decreasing of the strength of the LTE transmitting signal may be unnecessary. Conversely, if the SNR is relatively low, and the communication quality is poor although the strength of the CDMA 1X transmitting signal is relatively small, the strength of the LTE data transmitting signal may need to be lowered to prevent a call from being dropped.

### SUMMARY

Exemplary embodiments of the present invention provide a method for reducing an intermodulation noise signal.

Exemplary embodiments of present invention also provide communication terminal to reduce an intermodulation noise signal generated by an antenna and received by another antenna.

Additional features of the invention will be set forth in the description which follows, and in part will be apparent from the description, or may be learned by practice of the invention.

An exemplary embodiment of the present invention discloses communication terminal to perform wireless communication, the terminal including: a first channel including a first antenna to transmit a first signal at a first frequency; a second channel including a second antenna to receive or transmit one or more second signals at a frequency other than the first frequency of the first signal; and a control unit to measure a signal to noise ratio (SNR) in the second channel, and to control an output power of the first channel according to the measured SNR.

An exemplary embodiment of the present invention also discloses a method for reducing intermodulation noise generated by a communication terminal apparatus to perform wireless communication, the method including: measuring a signal to noise ratio (SNR) in a first channel; determining if the SNR is greater than a first threshold; and adjusting a second channel output power if the SNR is greater than the first threshold.

An exemplary embodiment of the present invention also discloses a method for reducing intermodulation noise, including: measuring a signal to noise ratio (SNR) in a first channel; determining if the SNR is less than a first threshold; measuring a strength of a signal in the first channel if the SNR is less than a first threshold; and decreasing a second channel output power if the strength of the signal is greater than or equal to a second threshold, wherein the signal corresponds to a signal of the second channel output power.

An exemplary embodiment of the present invention also discloses a non-transitory computer-readable media, the media including program instructions that, when executed, implement a method embodied by a communication terminal apparatus for reducing a noise signal generated for performing wireless communication, the method including: transmitting over a first channel of the communication terminal apparatus a first signal at a first frequency; receiving or transmitting over a second channel of the communication terminal apparatus one or more second signals at a frequency other than the first frequency of the first signal; and measuring a signal to noise ratio (SNR) in the second channel, determining if the measured SNR is less than a first threshold; and decreasing an output power of the first channel if the SNR is less than the first threshold and to increase the output power of the first channel if the SNR is greater than the first threshold.

An exemplary embodiment of the present invention also discloses a method for reducing intermodulation noise generated by a communication terminal apparatus to perform wireless communication, the method including: measuring a signal to noise ratio (SNR) in a first channel; and adjusting a second channel output power according to the SNR.

An exemplary embodiment of the present invention also discloses a method for reducing intermodulation noise generated by a communication terminal apparatus to perform wireless communication, the method including: measuring a strength of a signal in a first channel; and decreasing a second channel output power if the strength of the signal is greater than or equal to a first threshold, wherein the signal corresponds to a signal of the second channel output power.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a communication terminal apparatus according to an exemplary embodiment of the present invention.

FIG. 2 is a block diagram of a communication terminal apparatus according to an exemplary embodiment of the present invention.

FIG. 3 is a flowchart of a method for reducing intermodulation noise according to an exemplary embodiment of the present invention.

FIG. 4 is a flowchart of a method for reducing intermodulation noise according to an exemplary embodiment of the present invention.

FIG. 5 is a flowchart of a method for reducing intermodulation noise according to an exemplary embodiment of the present invention.

FIG. 6 is a flowchart of a method for reducing intermodulation noise according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element is referred to as being “connected to” another element, it can be directly connected to the other element, or intervening elements may be present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter a communication terminal apparatus or communication terminal, such as including, for example, handheld, portable or tablet computer or communication devices, and a method for cancelling, reducing or minimizing noise or a noise signal generated by a communication terminal apparatus will be described in more detail with reference to the drawings. Also, cancelling, reducing or minimizing noise or a noise signal may be used interchangeably, one for the other, and should not be construed in a limiting sense.

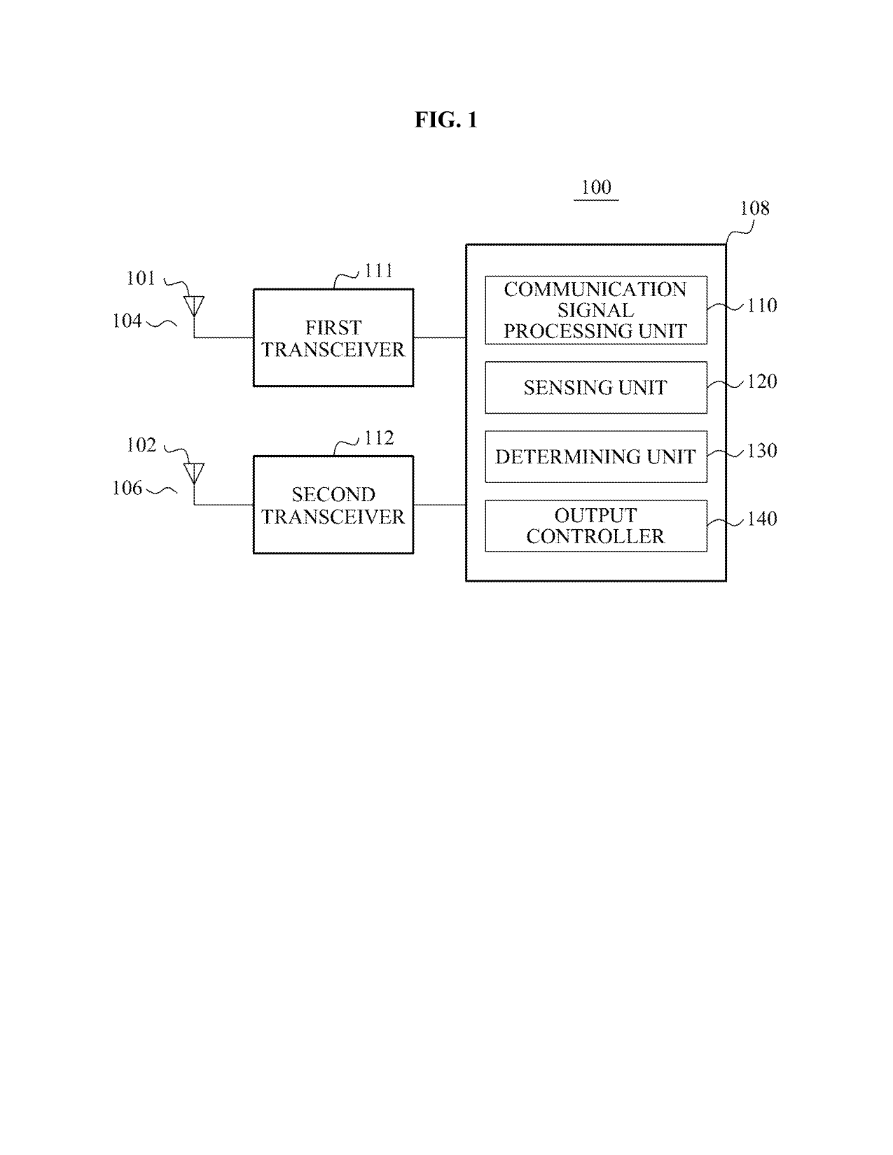

FIG. 1 is a block diagram of a communication terminal apparatus according to an exemplary embodiment of the present invention.

Referring to FIG. 1, a communication terminal apparatus 100 may perform data communication using a first transceiver 111, and a first antenna 101. The communication terminal apparatus 100 may include a first channel 104 including the first antenna 101 to transmit a first signal, such as a data signal, at a first frequency. The data communication may include, for example, a data communication of a Long Term Evolution (LTE) scheme. However, the data communication may not be limited thereto. The data communication may include a data communication of any other schemes, for example, a Code Division Multiple Access (CDMA) Evolution-Data Optimized (EV-DO), a wireless fidelity (WiFi), a wireless broadband (WiBro), and the like.

The communication control apparatus 100 includes a control unit 108. The control unit 108 includes any of various memory or storage media for storing software, program instructions, data files, data structures, and the like, and the control unit 108 also includes any of various processors, computers or application specific integrated circuits (ASICs) for example, to implement various operations in cancelling, reducing or minimizing generated noise or noise signals, as described herein. The software, media, and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware, or other modules to perform the operations of the described embodiments of the present invention.

Also, the control unit 108 may include the following units, controllers, or elements, which may perform one or more of the described functions and operations to perform noise cancellation, reduction, or minimization, according to exemplary embodiments. Also, the units, processors, or elements of the control unit 108 may be combined in performing the various described functions and operations. As further described herein, the control unit 108 may include a communication signal processing unit 110, a sensing unit 120, a determining unit 130, and an output controller 140.

The communication terminal apparatus 100 may perform a communication of a voice call, using a second transceiver 112 and a second antenna 102. The communication terminal apparatus 100 may include a second channel 106 including the second antenna 102 to receive or transmit one or more second signals, such as including voice signals, at a frequency other than the first frequency of the first signal. For example, the communication of the voice call may include a communication of a CDMA 1X scheme, an LTE scheme, etc.

The communication of the second transceiver 112 and the communication of the second antenna 102 may not be limited to a communication of a voice call, and may be performed in a separate or different frequency band, the separate or different frequency band may differ from the communication of the first transceiver 111 and the communication of the first antenna 101.

If a signal transmitted by the first transceiver 111 through the first antenna 101 is received by the second transceiver 112 through the second antenna 102, intermodulation noise may be generated and a noise reducing scheme may be applied, irrespective of a communication scheme.

A communication signal processing unit 110 of the communication terminal apparatus 100 may be a communication signal processing module to process the data communication through the first transceiver 111, the voice call through the second transceiver 112, and the like.

A sensing unit 120 may be configured to measure a signal to noise ratio (SNR) in a communication scheme associated with the second transceiver 112, for example, the CDMA 1X communication, and may compare the measured SNR to a first threshold. For example, the first threshold may correspond to 7.4 decibels (dB), but is not limited thereto.

A determining unit 130 may determine whether the measured SNR is less than the first threshold.

If the measured SNR is less than the first threshold, it may be determined that a quality of the voice call is degraded, and an output controller 140 may decrease a strength of an output signal (or output power) in the data communication associated with the first transceiver 111.

Through the decrease of the strength of the output signal (or output power) in the data communication associated with the first transceiver 111, the intermodulation noise generated if the output signal in the data communication associated with the first transceiver 111 is received by the second antenna 102, and transferred to the second transceiver 112, may be reduced. The SNR in the communication scheme associated with the second transceiver 112 may be increased, and the quality of the voice call may also be increased.

If the determining unit 130 determines that the measured SNR is greater than the first threshold, a further increase in the strength of the output signal (or output power) in the communication associated with the first transceiver 111 may be determined to have no effect on the quality of the voice call because the quality of the voice call is good. The output controller 140 may increase the strength of the output signal (or output power) in the communication associated with the first transceiver 111.

The method for adjusting (i.e., increasing and/or decreasing) the strength of the output signal (or output power) in the communication associated with the first transceiver 111 may be performed iteratively or continuously until the SNR is substantially similar to the first threshold. Although the method for adjusting the strength of the output signal (or output power) in the communication associated with the first transceiver 111 may be performed until the SNR is greater than or equal to the first threshold, the adjusting process may be performed iteratively or continuously until the SNR is substantially similar to the first threshold.

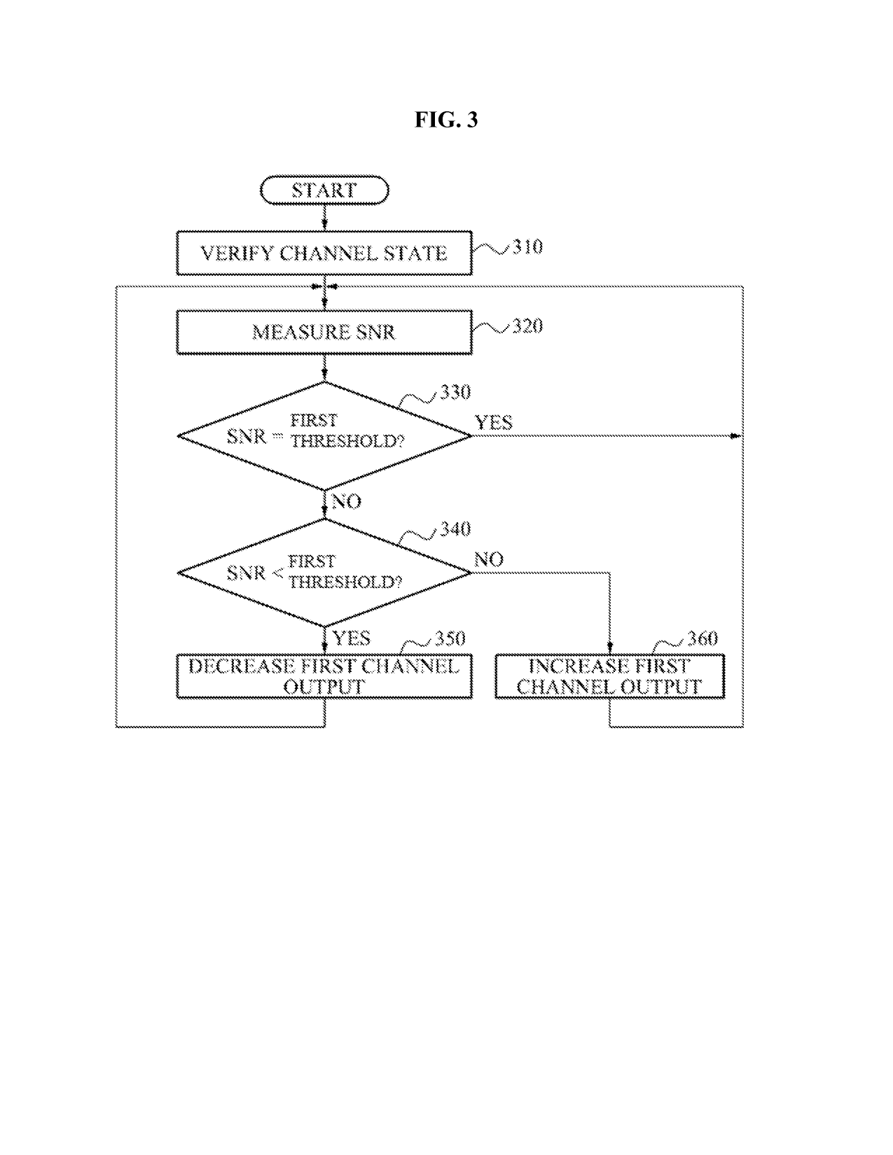

If the quality of the voice call is maintained at a reference level, a quality of the data communication of the first transceiver 111 may be increased to a higher level. A data communication rate may be improved while the quality of the voice call may be maintained, and the communication rate may be increased using provided resources. The method for increasing the data communication rate will be described in detail with reference to FIG. 3.

The communication terminal apparatus 100 may perform additional processes, rather than uniformly performing the method for adjusting the output signal based on the SNR in the communication scheme associated with the second transceiver 112.

Although a low SNR in the communication associated with the second transceiver 112 may result from the intermodulation noise generated if an output signal in the communication associated with the first transceiver 111 is received by the second transceiver 112 through the second antenna 102, the low SNR may also result from other factors, for example, a low strength of an output signal in the communication associated with the second transceiver 112, a peripheral environment, a combination thereof, and the like.

The additional process may correspond to a test method in which the output controller 140 may lower a strength of an output signal (or output power) in the communication associated with the first transceiver 111 if the determining unit 130 determines that the SNR in the communication associated with the second transceiver 112 is less than the first threshold.

If the strength of the output signal (or output power) in the communication associated with the first transceiver 111 is lowered through the test method and the SNR in the communication associated with the second transceiver 112 becomes greater than or equal to the first threshold, the determining unit 130 may determine that the low SNR results from the intermodulation noise.

If the determining unit 130 determines that the low SNR results from the intermodulation noise, the output controller 140 may decrease the strength of the output signal from the strength of the output signal in the communication associated with the first transceiver 111 before the test method was performed. The output controller 140 may reduce the strength of the output signal progressively and may continue decreasing the strength of the output signal until the SNR in the communication associated with the second transceiver 112 is greater than or equal to the first threshold. The decreasing of the strength of the output signal may be performed until the SNR is substantially similar to the first threshold.

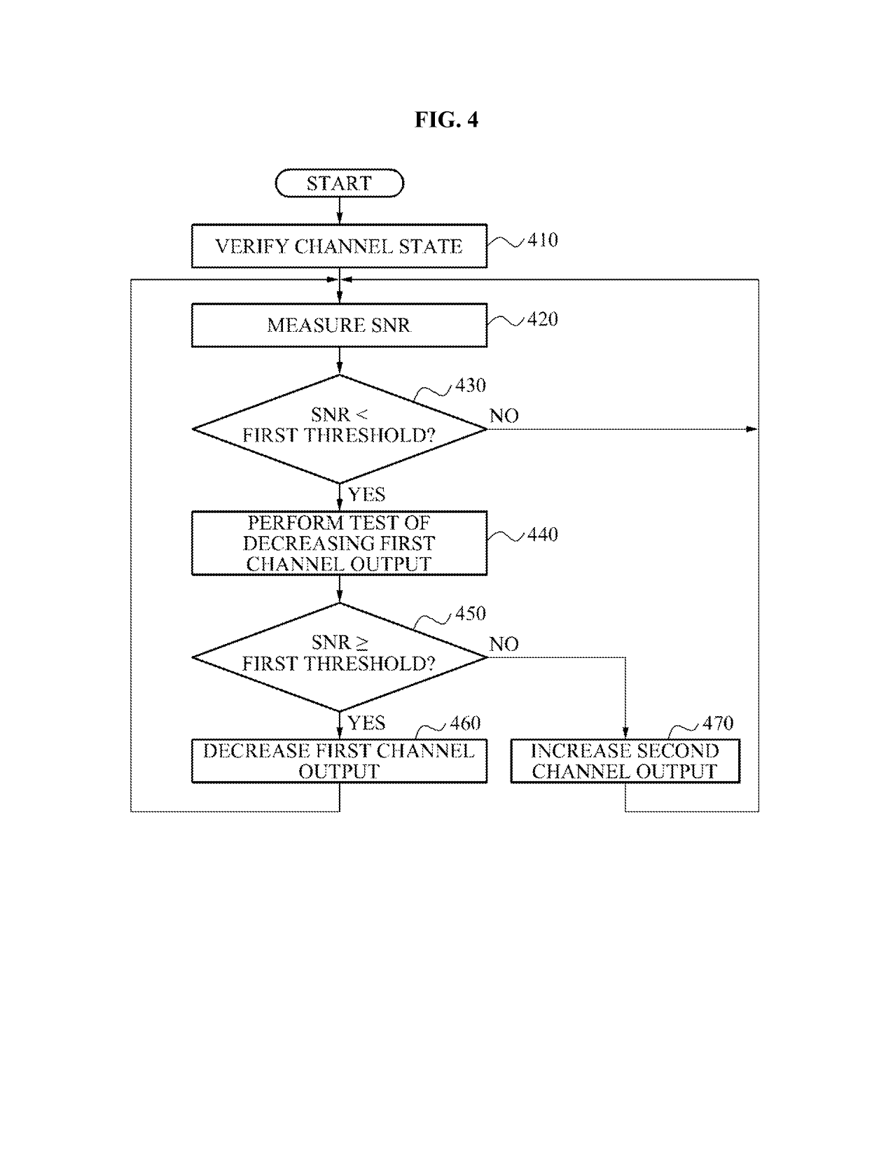

If the SNR fails to become greater than or equal to the first threshold although the strength of the output signal in the communication associated with the first transceiver 111 is reduced, as a result of the test method, intermodulation noise between channels may be determined to not be a cause of the low SNR. The output controller 140 may increase the strength of the output signal in the communication associated with the second transceiver 112. The increasing of the strength of the output signal may be performed until the SNR reaches the first threshold. The method for increasing the strength of the output signal will be described in detail with reference to FIG. 4.

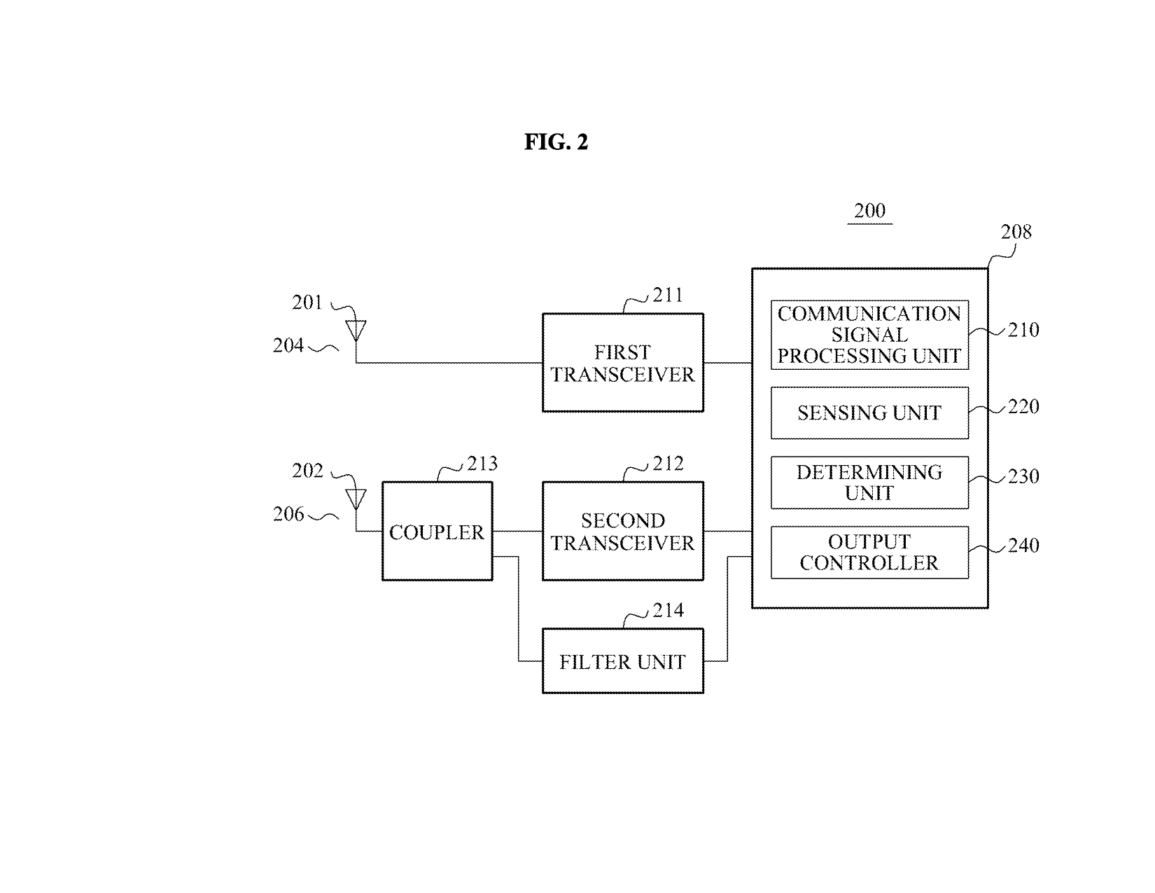

Instead of indirect determination through the test, a cause of the low SNR may be verified directly, by measuring a strength of an output signal in the communication associated with the transceiver 111, which is received by the second transceiver 112 through the second antenna 102. The method for directly measuring output signal strength will be described in detail with reference to FIG. 2.

FIG. 2 is a block diagram of a communication terminal apparatus according to an exemplary embodiment of the present invention.

Referring to FIG. 2, a communication terminal apparatus 200 may perform data communication using a first transceiver 211, and a first antenna 201. The communication terminal apparatus 200 may include a first channel 204 including the first antenna 201 to transmit a first signal, such as a data signal, at a first frequency. The data communication may include, for example, a data communication of a Long Term Evolution (LTE) scheme. However, the data communication may not be limited thereto. The data communication may include a data communication of any other schemes, for example, a Code Division Multiple Access (CDMA) Evolution-Data Optimized (EV-DO), a wireless fidelity (WiFi), a wireless broadband (WiBro), and the like.

The communication control apparatus 200 includes a control unit 208. The control unit 208 includes any of various memory or storage media for storing software, program instructions, data files, data structures, and the like, and the control unit 108 also includes any of various processors, computers or application specific integrated circuits (ASICs) for example, to implement various operations in cancelling, reducing or minimizing generated noise or noise signals, as described herein. The software, media, and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware, or other modules to perform the operations of the described embodiments of the present invention.

Also, the control unit 208 may include the following units, controllers, or elements, which may perform one or more of the described functions and operations to perform noise cancellation, reduction, or minimization, according to exemplary embodiments. Also, the units, processors, or elements of the control unit 208 may be combined in performing the various described functions and operations. As further described herein, the control unit 208 may include a communication signal processing unit 210, a sensing unit 220, a determining unit 230, and an output controller 240.

The communication terminal apparatus 200 may perform a communication of a voice call, using a second transceiver 212 and a second antenna 202. The communication terminal apparatus 200 may include a second channel 206 including the second antenna 202 to receive or transmit one or more second signals, such as including voice signals, at a frequency other than the first frequency of the first signal. For example, the communication of the voice call may include a communication of a CDMA 1X scheme, an LTE scheme, etc.

The test method described with reference to FIG. 1 may correspond to a method for determining whether a low SNR in a communication associated with the second transceiver 212 is caused by intermodulation noise generated if a signal output by the first transceiver 211 through the first antenna 201 is received by the second antenna 202, and transferred to the second transceiver 212. The determining method may be referred to as indirect determination, rather than direct determination.

A strength of a transmitting signal of the first transceiver 211 that is received by the second transceiver 212 may not be measured directly. The communication terminal apparatus 200 may include a coupler 213 between the second antenna 202 and the second transceiver 212 to transfer a signal received by the second antenna 202 to a filter unit 214, and the filter unit 214 to perform band-pass filtering and to transfer to the determining unit 230 a signal corresponding to a frequency of a communication of the first transceiver 211.

A communication signal processing unit 210 of the communication terminal apparatus 200 may be a communication signal processing module to process the data communication through the first transceiver 211, the voice call through the second transceiver 212, and the like.

The sensing unit 220 may measure an SNR in a communication associated with the second transceiver 212. Although the determining unit 230 may determine that the measured SNR is less than a first threshold, an output controller 240 may not decrease a strength of an output signal in a communication associated with the first transceiver 211, and the determining unit 230 may determine whether intermodulation noise is a cause of the low SNR, based on a strength of a signal passing through the filter unit 214.

If the strength of the signal passing through the filter unit 214 is greater than or equal to a second threshold, the determining unit 230 may determine that the intermodulation is the cause of the low SNR, and the output controller 240 may decrease the strength of the output signal in the communication associated with the first transceiver 211. The output controller 240 may progressively decrease the strength of the output signal in the communication associated with the first transceiver 211. The decreasing of the strength of the output signal may be performed continuously until the SNR is greater than or equal to the first threshold or until the SNR is substantially similar to the first threshold.

If the strength of the signal passing through the filter unit 214 is less than the second threshold and the SNR is less than the first threshold, the determining unit 230 may determine that the low SNR is caused by other factors, for example, a peripheral environment, and the like, as opposed to the intermodulation, and the output controller 240 may increase a strength of an output signal in the communication associated with the second transceiver 212. The increasing of the strength of the output signal in the communication associated with the second transceiver 212 may be performed continuously or iteratively until the SNR is greater than or equal to the first threshold, or until the SNR is substantially similar to the first threshold.

The communication terminal apparatus 200 may determine, in real time, the strength of the output signal in the communication associated with the first transceiver 211, which may be received by the second transceiver 212 through the second antenna 202. Determining the strength of the output signal may result in reducing the intermodulation noise more directly and accurately.

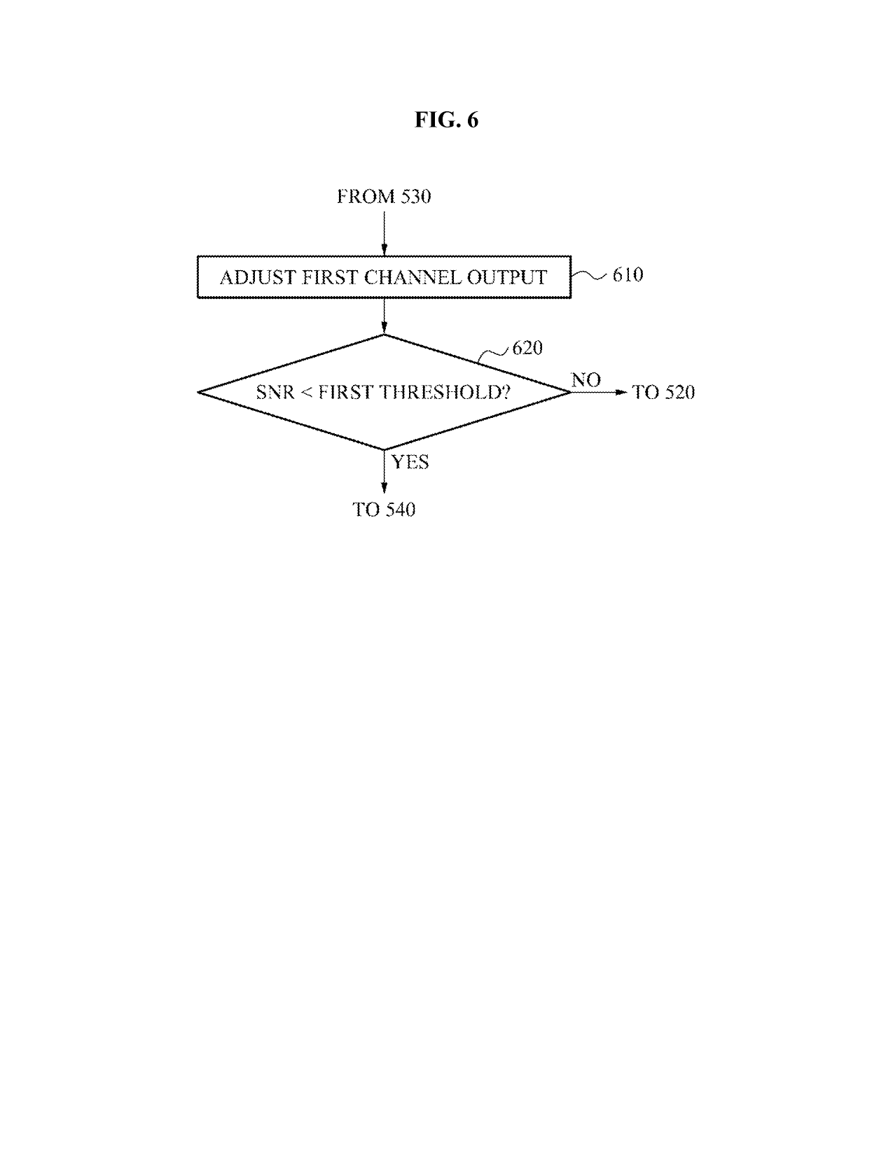

In order to improve an SNR rapidly, the method described with reference to FIG. 2 may be performed after a strength of an output signal of the first transceiver 211 is adjusted to a reference level, for example, a level determined based on a strength of an output signal of a second transceiver. The method for adjusting the output of a first transceiver to a reference level will be described with reference to FIG. 6.

FIG. 3 is a flowchart of a method for reducing intermodulation noise according to an exemplary embodiment of the present invention. Although FIG. 3 will described with reference to FIG. 1, aspects of the exemplary embodiments are not limited thereto.

Referring to FIG. 3, in operation 310, the sensing unit 120 may verify a state of a communication channel. The following method may be performed if communication signals are output by the first channel 104 associated with the first transceiver 111, and the second channel 106 associated with the second transceiver 112. The communication signals of the first channel 104 and the second channel 106 may be outputted simultaneously.

In operation 320, the sensing unit 120 may measure an SNR in a communication through the second channel 106. The communication through the second channel 106 may be, for example, the CDMA 1X communication scheme.

In operation 330, the determining unit 130 may compare the measured SNR to a first threshold. The first threshold may be, for example, approximately 7.4 dB. If the measured SNR is identical or substantially similar to the first threshold, the determining unit 130 may perform monitoring. The monitoring may be performed continuously or iteratively. The method repeats operation 320 and operation 330

In operation 330, if the measured SNR is determined to not be identical or substantially similar to the first reference threshold, in operation 340, the determining unit 130 may determine whether the SNR is less than the first threshold. If the SNR is less than the first threshold, in operation 350, the output controller 140 may decrease a strength of an output signal (or output power) in a communication associated with the first channel 104.

If the SNR is greater than the first threshold, in operation 360, the output controller 140 may increase the strength of the output signal (or output power) in the communication associated with the first channel 104. The strength of the output signal in the communication associated with the first channel 104 may be increased to a higher level.

Through the method of FIG. 3, an SNR in a communication associated with the second channel 106 in relation to a quality of a voice call may be substantially maintained at a level of the first threshold, at which a communication quality may be good, and an output of the communication associated with the first channel 104 corresponding to a data communication may be increased.

FIG. 4 is a flowchart of a method for reducing intermodulation noise according to an exemplary embodiment of the present invention. Although FIG. 4 will described with reference to FIG. 1, aspects of the exemplary embodiments are not limited thereto.

In operation 410, a channel state is verified. In operation 420, SNR is measured in a second channel 106. Operation 410 of verifying a channel state and operation 420 of measuring an SNR in the second channel 106 may be similar to the operation 310 and operation 320, respectively, of FIG. 3. In operation 430, the determining unit 130 may determine whether the measured SNR is less than a first threshold, by comparing the measured SNR to the first threshold. The first threshold may be, for example, 7.9 dB. If the measured SNR is not less than a first threshold, the method repeats operation 420 and operation 430.

If the measured SNR is greater than or equal to the first threshold, the operation 420 and operation 430 may be performed iteratively or continuously to monitor the SNR. If the measured SNR is less than the first threshold in the operation 430, operation 440 and subsequent operations may be performed because a communication quality may be deteriorated.

An SNR that is less than the first threshold may be caused by intermodulation noise generated if an output signal in a communication through a first channel 104 associated with the first transceiver 111 is received by the second transceiver 112 through the second antenna 102, or may be caused by other factors, for example, a low strength of an output signal in a communication through a second channel 106 associated with the second transceiver 112, a peripheral environment, combinations thereof, and the like.

In operation 440, a test for decreasing a strength of an output signal may be performed. In operation 440, the output controller 140 may perform the test of decreasing the strength of the output signal in the communication through the first channel 104 associated with the first transceiver 111.

In operation 450, the determining unit 130 may determine whether the SNR in the communication associated with the second transceiver 112 may be greater than or equal to the first threshold.

If the SNR becomes greater than or equal to the first threshold, it may be determined that the low SNR may be caused by the intermodulation noise. Accordingly, in operation 460, the output controller 140 may decrease the strength of the output signal in the communication through the first channel 104 associated with the first transceiver 111, from the strength before the test was performed.

If the SNR is not greater than or equal to the first threshold, although the strength of the output signal in the communication through the first channel 104 associated with the first transceiver 111 may be reduced in the test method, the intermodulation noise may be determined to not be a cause of the low SNR. In operation 470, the output controller 140 may increase the strength of the output signal in the communication through the second channel 106 associated with the second transceiver 112.

A communication quality of the first channel 104 and the second channel 106 may be increased, without a decrease in the strength of the output signal in the communication through the first channel 104.

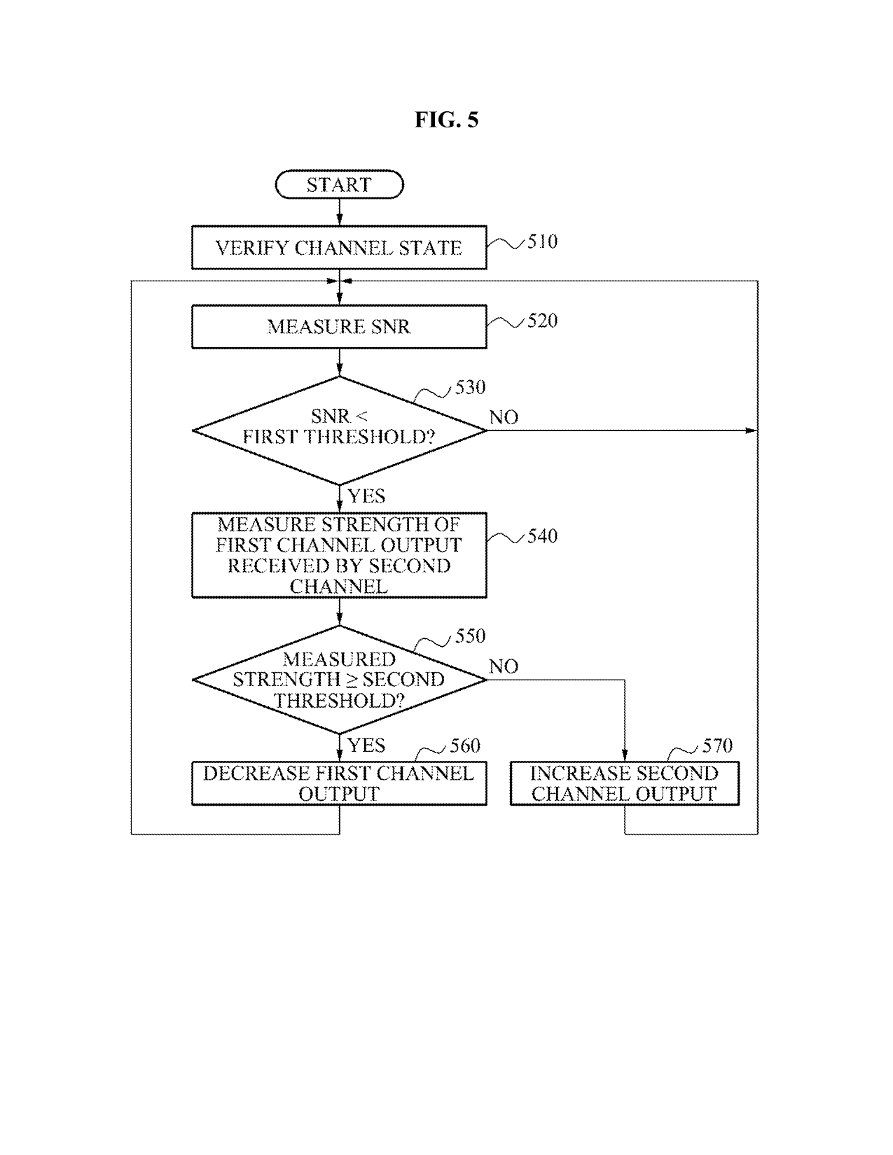

FIG. 5 is a flowchart of a method for reducing intermodulation noise according to an exemplary embodiment of the present invention.

Although FIG. 5 will described with reference to FIG. 2, aspects of the exemplary embodiments are not limited thereto. Aspects of FIG. 5 may be combined with FIG. 3 or FIG. 4.

In operation 510, a channel state is verified. In operation 520, a SNR is measured in a communication associated with a second channel 206 by the sensing unit 220. The operation 510 and the operation 520 may be similar to the operation 310 and the operation 320, respectively, of FIG. 3 or the operation 410 and the operation 420, respectively, of FIG. 4 and thus, descriptions thereof will be omitted for brevity.

As shown in FIG. 2, the coupler 213 may be disposed between the second antenna 202 and the second transceiver 212. Accordingly, a signal received by the second antenna 202 may be transferred to the filter unit 214 by the coupler 213. The filter unit 214 may perform band-pass filtering and may transfer to the determining unit 230 a signal corresponding to a frequency of a communication of the first transceiver 211.

A strength of a communication signal of the first channel 204, which may be received by the second channel 206, may be monitored. The strength of the communication signal of the first channel 206 may be monitored in real time.

In operation 530, it is determined if a SNR in a communication associated with the second channel 206 is less than a first threshold. If the SNR in the communication associated with the second channel 206 is not less than the first threshold, operation 520 and operation 530 are repeated. If the SNR in the communication associated with the second channel 206 is less than a first threshold, in operation 540, the sensing unit 230 may measure a strength of an output signal in the communication associated with the first channel 204, which may be received by the second channel 206.

In operation 550, the determining unit 230 may determine whether the measured strength is greater than or equal to a second threshold. If the measured strength is greater than or equal to the second threshold, it may be determined that the low SNR in the communication associated with the second channel 206 may be caused by intermodulation.

Accordingly, in operation 560, the output controller 240 may decrease a strength of an output signal in a communication associated with the first channel 204.

If the strength of the output signal in the communication associated with the first channel 204, which may be received by the second channel 206, is less than the second threshold and the SNR in the communication associated with the second channel 206 is less than the first threshold, it may be determined that the low SNR in the communication may be caused by other factors for example, a peripheral environment, and the like, rather than the intermodulation.

If the strength of the output signal in the communication associated with the first channel 204, which is received by the second channel 206, is less than the second threshold, in operation 570, the output controller 240 may increase the strength of the output signal in the communication associated with the second channel 206.

In the method of FIG. 5, by measuring the strength of the output signal in the communication associated with the first channel 204, which may be received by the second channel 206, it may be determined whether the low SNR in the communication associated with the second channel 206 results from a factor generated if the output signal of the first channel 204 is received by the second channel 206.

A response may be performed by adjusting the strength of the output signal in the communication associated with the first channel 204 based on a strength of an output signal in a communication associated with the second channel 206 before the determination is performed. The adjusting of the strength of the output signal in the communication associated with the first channel 204 may not be performed in advance of the determination, and may be performed in conjunction with the determination or may be performed in lieu of the determination.

FIG. 6 is a flowchart of a method for reducing intermodulation noise according to an exemplary embodiment of the present invention. Although FIG. 6 will described with reference to FIG. 5 and FIG. 2, aspects of the exemplary embodiments are not limited thereto.

If the SNR in the communication associated with the second channel 206 is determined to be less than the first threshold, in operation 530 of FIG. 5, the strength of the output signal in the communication associated with the first channel 204 may be adjusted in operation 610.

The method for adjusting the strength of the output signal in the communication associated with the first channel 204 may be performed by referring to Table 1 based on a level of an output signal in the communication associated with the second channel 206.

TABLE 1

| P | LTE B13 (dBm) |
|---|---|
| P < 18 | 21 |
| 18 ≦ P < 19 | 19 |
| 19 ≦ P < 20 | 16 |
| 20 ≦ P < 21 | 14 |
| 21 ≦ P | 12 |

In Table 1, P may refer to a power of a signal corresponding to a strength of a transmitting signal of the second channel 206, for example, a CDMA 1X voice channel.

In operation 610, the strength of the transmitting signal of the first channel 204, for example, a strength of a transmitting signal of an LTE data channel, may be adjusted based on a strength of a transmitting signal of the second channel 206, by referring to Table 1, i.e., a look-up table (LUT).

The SNR in the communication associated with the second channel 206 may be improved by adjusting, in advance, the strength of the output signal in the communication associated with the first channel 204.

In operation 620, it is determined if the SNR in the communication associated with the second channel 206 is less than the first threshold. If the SNR in the communication associated with the second channel 206 is greater than or equal to the first threshold, it may be determined that the intermodulation noise may be resolved and the method proceeds to operation 520 of FIG. 5. The SNR in the communication associated with the second channel 206 may be monitored until the SNR in the communication associated with the second channel 206 is lowered to be less than the first threshold.

If it is determined, in operation 620, that the SNR is less than the first threshold although the operation 610 is performed, the method proceeds to operation 540 of FIG. 5 and the subsequent operations may be performed to improve the SNR.

According to exemplary embodiments, the LUT may be implemented as Table 2.

TABLE 2

| Psum | LTE B13 (dBm) |
|---|---|
| Psum < 24 | 21 |
| 24 ≦ Psum < 25 | 19 |
| 25 ≦ Psum < 26 | 16 |
| 26 ≦ Psum < 27 | 14 |
| 27 ≦ Psum | 12 |

In Table 2, Psum may refer to an overall power of a signal obtained by adding a strength of a transmitting signal of the second channel 206, for example, the CDMA 1X voice channel, to a strength of the transmitting signal of the first channel 204 that may be input to the second channel 206.

With reference to Table 2, in operation 610, the strength of the transmitting signal of the first channel 204, for example, the strength of the transmitting signal of the LTE data channel, may be adjusted based on the sum of the strength of the transmitting signal of the second channel 206, and the strength of the transmitting signal of the first channel 204, which may be received by the second channel 206.

According to exemplary embodiments of the present invention, the SNR in the communication associated with the second channel 206 may be improved by adjusting a level of an output signal in the communication associated with the first channel 204 in advance, in the method for adjusting the SNR of FIG. 5.

The exemplary embodiments according to the present invention may be recorded in non-transitory computer-readable media including program instructions to implement various operations embodied by a computer. The medium may also include, alone or in combination with the program instructions, data files, data structures, and the like. The medium and program instructions may be those specially designed and constructed for the purposes of the present invention, or they may be of the kind well-known and available to those having skill in the computer software arts. Examples of non-transitory computer-readable media include magnetic media, such as hard disks, floppy disks, and magnetic tape; optical media, such as CD ROM discs and DVD; magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, a transmission rate of a data communication may not be decreased while deterioration of a voice communication or loss of a voice signal may be reduced, by adjusting a strength of an LTE transmitting signal based on a result of verifying a signal to noise ratio (SNR) in real time, whereby the transmission rate of the data communication may be increased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A communication terminal to perform wireless communication, the terminal comprising:
a first channel including a first antenna to transmit a first signal at a first frequency;
a second channel including a second antenna to receive or transmit one or more second signals at a frequency other than the first frequency of the first signal; and
a control unit to measure a signal to noise ratio (SNR) in the second channel, and to control an output power of the first channel according to the measured SNR.

2. The terminal of claim 1, wherein the control unit decreases the output power of the first channel if the SNR is less than the first threshold and increases the output power of the first channel if the SNR is greater than the first threshold.

3. The terminal of claim 1, wherein the control unit comprises:
a sensing unit to measure the SNR in the second channel;
a determining unit to determine if the measured SNR is less than a first threshold; and
an output controller to decrease the output power of the first channel if the SNR is less than the first threshold and to increase the output power of the first channel if the SNR is greater than the first threshold.

4. The terminal of claim 1, wherein if the SNR is greater than the first threshold, the control unit increases the output power of the first channel until the SNR is less than the first threshold.

5. The terminal of claim 1, wherein the output power of the first channel is increased or decreased according to a look-up table.

6. The terminal of claim 1, wherein the output power of the first channel is increased or decreased iteratively or continuously.

7. The terminal of claim 3, further comprising:
a coupler to receive the second signal and to transfer the second signal to a filter,
the filter to filter the second signal, and to transfer the filtered second signal to the determining unit,
wherein the determining unit compares a strength of a signal corresponding to the first signal in the filtered second signal to a second threshold.

8. The terminal of claim 1, wherein first signal comprises a data signal and the one or more second signals comprise a voice signal.

9. The terminal of claim 3, wherein the determining unit compares an output power of the first signal to a second threshold.

10. A method for reducing intermodulation noise generated by a communication terminal apparatus to perform wireless communication, the method comprising:
measuring a signal to noise ratio (SNR) in a first channel;
determining if the SNR is greater than a first threshold; and
adjusting a second channel output power if the SNR is greater than the first threshold.

11. The method of claim 10, further comprising:
decreasing the second channel output power if the SNR is less than the first threshold.

12. The method of claim 10, wherein the second channel output power is increased until the SNR is less than the first threshold.

13. The method of claim 10, wherein the second channel output power is iteratively or continuously increased.

14. The method of claim 10, wherein the second channel output power is increased according to a look-up table.

15. The method of claim 10, wherein a signal corresponding to the second channel comprises a data signal and a signal corresponding to the first channel comprises a voice signal.

16. The method of claim 10, further comprising:
decreasing the second channel output power if the SNR is less than the first threshold;
determining if the SNR has changed and is greater than or equal to the first threshold;
increasing the first channel output power if the changed SNR is less than the first threshold; and
decreasing the second channel output power if the changed SNR is greater than or equal to the first threshold.

17. The method of claim 16, further comprising:
when the changed SNR is less than the first threshold, a decrease in the SNR is not due to intermodulation.

18. A method for reducing intermodulation noise, comprising:
measuring a signal to noise ratio (SNR) in a first channel;
determining if the SNR is less than a first threshold;
measuring a strength of a signal in the first channel if the SNR is less than a first threshold; and
decreasing a second channel output power if the strength of the signal is greater than or equal to a second threshold,
wherein the signal corresponds to a signal of the second channel output power.

19. The method of claim 18, further comprising:
increasing the first channel output power if the measured strength of the signal in the first channel is greater than or equal to the second threshold.

20. The method of claim 18, further comprising:
adjusting the second channel output power if the SNR is less than a first threshold;
determining if the SNR has changed and is greater than the first threshold; and
measuring the strength of the signal in the first channel if the changed SNR is greater than or equal to the first threshold.

21. The method of claim 18, wherein the strength of the second channel output power is iteratively or continuously decreased.

22. The method of claim 18, wherein the second channel output power is decreased according to a look-up table.

23. The method of claim 18, wherein a signal corresponding to the second channel comprises a data signal and a signal corresponding to the first channel comprise a voice signal.

24. A non-transitory computer-readable media, the media including program instructions that, when executed, implement a method embodied by a communication terminal apparatus for reducing a noise signal generated for performing wireless communication, the method comprising:
transmitting over a first channel of the communication terminal apparatus a first signal at a first frequency;
receiving or transmitting over a second channel of the communication terminal apparatus one or more second signals at a frequency other than the first frequency of the first signal; and
measuring a signal to noise ratio (SNR) in the second channel; determining if the measured SNR is less than a first threshold; and decreasing an output power of the first channel if the SNR is less than the first threshold and to increase the output power of the first channel if the SNR is greater than the first threshold.

25. The non-transitory computer readable media of claim 24, wherein if the SNR is greater than the first threshold, the output control unit increases the output power of the first channel until the SNR is less than the first threshold.

26. The non-transitory computer readable media of claim 24, wherein the first signal comprises a data signal and the second signal comprises a voice signal.

27. A method for reducing intermodulation noise generated by a communication terminal apparatus to perform wireless communication, the method comprising:
measuring a signal to noise ratio (SNR) in a first channel; and
adjusting a second channel output power according to the SNR.

28. The method of claim 27, further comprising:
measuring a strength of a signal in the first channel; and
decreasing the second channel output power if the strength of the signal is greater than or equal to a second threshold,
wherein the signal corresponds to a signal of the second channel output power.

29. A method for reducing intermodulation noise generated by a communication terminal apparatus to perform wireless communication, the method comprising:
measuring a strength of a signal in a first channel;
decreasing a second channel output power if the strength of the signal is greater than or equal to a first threshold,
wherein the signal corresponds to a signal of the second channel output power.

30. The method of claim 29, further comprising:
measuring a signal to noise ratio (SNR) in the first channel;
adjusting a second channel output power according to the SNR.
